(19) United States
(12) Patent Application Publication
(10) Pub. No.: US 2022/0146997 A1
(43) Pub. Date: May 12, 2022

(54) DEVICE AND METHOD FOR TRAINING A CONTROL STRATEGY WITH THE AID OF REINFORCEMENT LEARNING

(71) Applicant: Robert Bosch GmbH, Stuttgart (DE)

(72) Inventors: Daria Stepanova, Leonberg (DE); Johannes Oetsch, Wien (AT); Nysret Musliu, Wien (AT); Thomas Eiter, Wien (AT); Felix Milo Richter, Tettnang (DE)

(21) Appl. No.: 17/453,610

(22) Filed: Nov. 4, 2021

(30) Foreign Application Priority Data
Nov. 11, 2020 (DE) 10 2020 214 177.0

(51) Int. Cl. G05B 15/02; G06K 9/62; G06N 20/00

(52) U.S. Cl. CPC G05B 15/02; G06N 20/00; G06K 9/626; G06K 9/6262

(57) ABSTRACT

A method for training a control strategy with the aid of reinforcement learning. The method includes carrying out passes, in each pass, an action that is to be carried out being selected for each state of a sequence of states of an agent, for at least some of the states the particular action being selected by specifying a planning horizon that predefines a number of states, ascertaining multiple sequences of states, reachable from the particular state, using the predefined number of states, by applying an answer set programming solver to an answer set programming program which models the relationship between actions and the successor states that are reached by the actions, selecting the sequence that delivers the maximum return, and selecting an action as the action for the particular state via which the first state of the selected sequence may be reached, starting from the particular state.

### FIELD

Various exemplary embodiments of the present invention relate in general to a device and a method for training a control strategy with the aid of reinforcement learning.

### BACKGROUND INFORMATION

A control device for a machine such as a robot may be trained using so-called reinforcement learning (RL) for performing a certain task, for example in a manufacturing process. The performance of the task typically encompasses the selection of an action for each state of a sequence of states, i.e., may be regarded as a sequential decision problem. Depending on the states that are reached due to the selected actions, in particular the end state, the actions result in a certain return, which determines whether the actions allow reaching an end state for which a reward (for example, for achieving the objective of the task) is granted.

Reinforcement learning enables an agent (a robot, for example) to learn from experience, in that the robot adapts its behavior in such a way that the return received by the robot over the course of time is maximized. There are simple trial and error-based RL methods in which the agent requires no knowledge of the control scenario and which are guaranteed to converge to an optimal control policy when they are provided with enough time. However, in practice the convergence to an optimal control policy may be very slow. This is particularly true for the control scenario in which rewards are difficult to find.

Efficient approaches are desirable which allow the learning process to be speeded up by using prior knowledge about the control scenario, for example by forming a model, for example concerning the behavior of the environment.

### SUMMARY

According to various specific embodiments of the present invention, a method for training a control strategy with the aid of reinforcement learning is provided, including carrying out multiple reinforcement learning training passes, in each reinforcement learning training pass an action that is to be carried out being selected for each state of a sequence of states of an agent, beginning with an initial state of the control pass, for at least some of the states the particular action being selected by specifying a planning horizon that predefines a number of states, ascertaining multiple sequences of states, reachable from the particular state, using the predefined number of states, by applying an answer set programming solver to an answer set programming program which models the relationship between actions and the successor states that are reached by the actions, selecting from the ascertained sequences the sequence among the ascertained sequences that delivers the maximum return, the return that is delivered by an ascertained sequence being the sum of the rewards that are obtained upon reaching the states of the sequence, and selecting an action as the action for the particular state via which the first state of the selected sequence may be reached, starting from the particular state.

According to a further exemplary embodiment of the present invention, a control device is provided which is configured to carry out the above method or to control a robotic device according to the control strategy trained according to the above method.

The above-described method and the control device may allow the speed of the training to be significantly increased, even when the planning horizon is only relatively small (for example, specifies only a small predefined number of states, for example between 2 and 10) compared to an RL method without a planning component. In the process, an RL method might be practicably usable in the first place, for example in scenarios in which a robotic device must learn during operation (for example, for a real-time adaptation to changing conditions such as terrain). Due to the limitation to one planning horizon, it is not necessary for the planning component (implemented by the answer set programming solver) to find an end state (i.e., a state at which the training pass ends), which for some control scenarios is difficult or impossible. Instead, the planning component is used repeatedly (multiple times during a training pass) with a relatively small planning horizon (for example, one that, at least for the initial states of the training pass, is not sufficient until an end state is reached) until an end state is ultimately reached.

This approach may be used together with any off-policy RL method, the properties of the off-policy RL method such as convergence and optimal control policy being retained, but the learning by the exploitation of prior knowledge (which is introduced by the answer set programming program, and thus as a model) and the planning being speeded up. The (model-based) planning component conducts the exploration, but the agent learns from actual experience (for example, ascertained by sensor data). Information concerning details of the environment not reflected by the model (which is provided in the form of the answer set programming program) is thus retained. This allows use of a simplified or overoptimistic model.

Various exemplary embodiments are disclosed herein.

Exemplary embodiment 1 is the above-described method for training a control strategy with the aid of reinforcement learning.

Exemplary embodiment 2 is the method according to exemplary embodiment 1, for a state that is reached in a reinforcement learning training pass, a check being made as to whether the state was reached for the first time in the multiple reinforcement learning training passes, and the action being ascertained by ascertaining the multiple sequences, selecting the sequence among the ascertained sequences that delivers the maximum return, and selecting the action via which the first state of the selected sequence, starting from the state, may be reached, if the state was reached for the first time in the multiple reinforcement learning training passes.

This ensures that prior knowledge contained in the answer set programming program is used for each state.

Exemplary embodiment 3 is the method according to exemplary embodiment 2, for a state that has already been reached in the multiple reinforcement learning training passes, the action being selected according to the previously trained control strategy, or randomly.

If a state has already been reached, the prior knowledge has already been correspondingly entered once into the selection for an action for the state. Dispensing with the use of the planning component for states already visited ensures that the training duration is not unnecessarily prolonged by use of the planning component.

Exemplary embodiment 4 is the method according to one of exemplary embodiments 1 through 3, for at least some of the states the particular action being selected by specifying a first planning horizon that predefines a first number of states, ascertaining multiple sequences of states that are reachable from the state, using the first number of states, by applying an answer set programming solver to an answer set programming program which models the relationship between actions and the successor states that are reached by the actions, and

if, for ascertaining the action for the particular state, a predefined available computation budget is depleted, selecting from the ascertained sequences, using the first number of states of the sequence, the sequence among the ascertained sequences that delivers the maximum return, and selecting an action as the action for the particular state via which the first state of the selected sequence may be reached, starting from the particular state; and
if, for ascertaining the action for the particular state, a predefined available computation budget is not yet depleted, specifying a second planning horizon that predefines a second number of states, the second number of states being greater than the first number of states, ascertaining multiple sequences of states that are reachable from the state, using the second number of states, by applying the answer set programming solver to the answer set programming program which models the relationship between actions and the successor states that are reached by the actions, selecting from the ascertained sequences, using the second number of states, the sequence among the ascertained sequences that delivers the maximum return, and selecting an action as the action for the particular state via which the first state of the selected sequence, starting from the particular state, may be reached.

The computing time invested in the planning may be controlled in this way. In particular, the RL method may be adapted to given time limitations (for example, for learning during operation) by suitably specifying the computation budget. The computation budget is a time budget or a budget of computing operations, for example.

Exemplary embodiment 5 is the method according to one of exemplary embodiments 1 through 4, the answer set programming solver assisting with multi-shot solving, and the multiple sequences for successive states in a reinforcement learning training pass being ascertained by multi-shot solving with the aid of the answer set programming solver.

The use of multi-shot solving reduces the computing effort and time expenditure required for the planning component.

Exemplary embodiment 6 is a control method that includes controlling a robotic device based on the control strategy trained according to one of exemplary embodiments 1 through 5.

Exemplary embodiment 7 is a control device that is configured to carry out a method according to one of exemplary embodiments 1 through 6.

Exemplary embodiment 8 is a computer program that includes program instructions which, when executed by one or multiple processors, cause the one or multiple processors to carry out a method according to one of exemplary embodiments 1 through 6.

Exemplary embodiment 9 is a computer-readable memory medium on which program instructions are stored which, when executed by one or multiple processors, cause the one or multiple processors to carry out a method according to one of exemplary embodiments 1 through 6.

Exemplary embodiments of the present invention are illustrated in the figures and explained in greater detail in the following description. In the figures, identical reference numerals generally refer overall to the same parts in the multiple views. The drawings are not necessarily true to scale; rather, the primary focus is to illustrate the main features of the present invention.

### BRIEF DESCRIPTION OF THE DRAWINGS

FIG. 1 shows a robotic device, in accordance with an example embodiment of the present invention.

FIG. 2 illustrates an interaction between a learning agent and its control environment, the agent using a planning component according to one specific embodiment of the present invention.

FIG. 3 shows a flowchart that illustrates a method for training a control strategy with the aid of reinforcement learning, in accordance with an example embodiment of the present invention.

### DETAILED DESCRIPTION OF EXAMPLE EMBODIMENTS

The various specific embodiments, in particular the exemplary embodiments described below, may be implemented with the aid of one or multiple circuits. In one specific embodiment, a “circuit” may be understood to mean any type of logic-implementing entity, which may be hardware, software, firmware, or a combination thereof. Therefore, in one specific embodiment a circuit may be a hard-wired logic circuit, or a programmable logic circuit such as a programmable processor, for example a microprocessor. A circuit may also be software that is implemented or executed by a processor, for example any type of computer program. In accordance with one alternative specific embodiment, any other type of implementation of the particular functions, described in greater detail below, may be understood as a circuit.

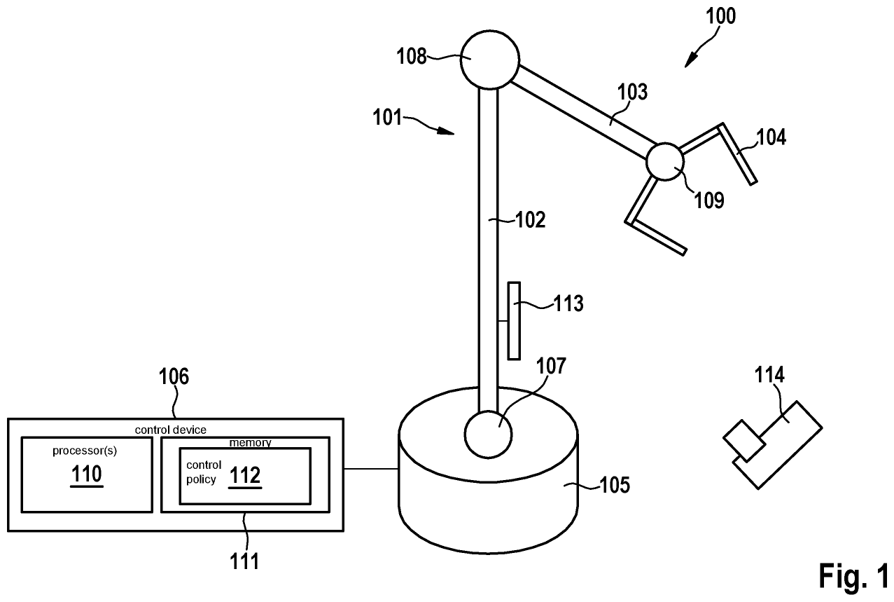

FIG. 1 shows a robotic device 100.

Robotic device 100 includes a robot 101, for example an industrial robot arm for handling or mounting a workpiece or one or multiple other objects 114. Robot 101 includes manipulators 102, 103, 104 and a base 105 (a mounting, for example) that supports manipulators 102, 103, 104. The term “manipulator” refers to the movable parts of robot 101, whose actuation allows a physical interaction with the environment, for example to perform a task. For controlling the robot, robotic device 100 contains a (robotic) control device 106 that is configured in such a way that it implements the interaction with the environment according to a control program. Last member 104 (farthest from mounting 105) of manipulators 102, 103, 104 is also referred to as an end effector 104, and may contain one or multiple tools such as a welding torch, a gripping instrument, a painting device, or the like.

The other manipulators 102, 103 (closer to base 105) may form a positioning device, so that together with end effector 104, a robot 101 with end effector 104 at its end is provided. Robot 101 is a mechanical arm that may fulfill functions similarly to a human arm (possibly including a tool at its end).

Robotic device 101 may include articulated elements 107, 108, 109 that connect manipulators 102, 103, 104 to one another and to mounting 105. An articulated element 107, 108, 109 may include one or multiple articulated joints, each of which may allow a rotational movement and/or a translational movement (i.e., a displacement) of the associated manipulators relative to one another. The movement of manipulators 102, 103, 104 may be initiated with the aid of actuators that are controlled by control device 106.

The term “actuator” may be understood as a component that is configured in such a way that it influences a mechanism or process as a response to the actuation. The actuator may convert instructions output by control device 106 (so-called activation) into mechanical movements. The actuator, for example an electromechanical converter, may be configured to convert electrical energy into mechanical energy as a response to the actuation.

Robot 101 may include sensors 113 (for example, one or multiple cameras, position sensors, etc.) that are configured to ascertain the state of the robot and of the one or multiple manipulated objects 114 (i.e., the environment) which result from the actuation of the actuators and the resulting movements of the robot.

In the present example, control device 106 includes one or multiple processors 110, and a memory 111 that stores program code and data on the basis of which processor 110 controls robot 101. According to various specific embodiments, control device 106 controls robot 101 according to a control policy 112 that is implemented by the control device.

Reinforcement learning (RL) is one option for generating a control policy. Reinforcement learning is characterized by a trial and error search and a delayed reward. In contrast to supervised learning of a neural network, which requires labels for training, RL uses a trial and error mechanism to learn an association of states with actions in such a way that a reinforcement signal, referred to as a return, is maximized. By use of trial and error, in RL an attempt is made to find the actions that (ultimately) result in higher rewards by testing them. However, finding a good control policy may require a great deal of time.

According to various specific embodiments, reinforcement learning is speeded up by providing a planning component that uses a model of the controlled system (for example, the robot and the environment on which the robot acts or which acts on the robot) in order to recommend promising actions to the agent.

The primary challenge may be regarded as having to carefully weigh the additional computing resources required for the planning against the advantages that result from leading the agent to states with higher rewards.

According to various specific embodiments, the planning component (and in particular the model) is implemented with the aid of answer set programming (ASP). Answer set programming is a declarative problem-solving approach that combines a modeling high-level language, for describing the search space of candidate solutions for a given problem, with efficient solvers for the effective computation of such solutions.

Answer set programming includes a simple but meaningful modeling language for describing the controlled system in a compact manner. The modeling language contains optimization functions that allow rewards to be optimized. The search for plans (i.e., sequences of states or corresponding actions) that generate maximum rewards within a given planning horizon may then be expressed with the aid of particular optimization statements.

An answer set programming (ASP) solver may be used as a solver to search for optimal plans within a given planning horizon. Answer set programming solvers are particularly suitable when the problems are difficult to solve and contain many limitations. In addition, the control policy may be designed in such a way that multi-shot solving may be utilized in order to reuse computations whenever possible and thus increase the computation speed.

For describing the implementation of a planning component with the aid of answer set programming, the terminology used in reinforcement learning (RL) is introduced below.

In reinforcement learning, the interaction between an agent and the environment (for example, the environment of a robot that interacts with actions of the robot and influences the particular state into which the robot comes for a certain action) is formalized as a Markov decision process (MDP). An MDP includes a finite set [symbol] of states. For each state S∈ [symbol] , [symbol] (S) is a finite set of actions that the agent may carry out in state [symbol] . When an agent is in a state Sₜ at a time t∈ [symbol] and carries out an action Aₜ∈ [symbol] (Sₜ), it comes into a state Sₜ₊₁ at the next point in time t+1 and receives a reward Rₜ₊₁ from a finite set [symbol] ⊂ [symbol] of numerical rewards (for example, a robot receives a reward when it has moved an object to a desired place). A trajectory of the agent-environment interaction, which begins in a state S₀, has the form

S₀A₀R₁S₁A₁R₂S₂A₂R₃ . . .

The dynamics of the interaction are given by a function

p: [symbol] × [symbol] × [symbol] × [symbol] [symbol] [0,1],

where p(S′, R, S, A) is the probability of coming into state S′ when carrying out action [symbol] in state [symbol] , and thereby obtaining reward R.

A control policy indicates which action in a certain state is selected. The agent aims to improve its control policy based on experience, so that in any given state Sₜ it maximizes its expected discounted return

$${G}_{t} = {\sum }_{k = 0}^{∞} {γ}^{k} {R}_{t + k + 1} ,$$

where γ, 0≤γ≤1 is the discount rate that expresses the present value of future rewards.

The improvement of a control policy may take place by learning a value estimation function. The value estimation function is a mapping of states or state-action pairs onto expected returns. The value estimation function (or also just “value function”) is updated according to the interactions of the agent with the environment. A key objective in reinforcement learning is weighing between the exploration of (unexplored) actions and the exploitation of what has already been learned. A method is referred to as an off-policy method when the agent follows a more explorative control policy b in order to improve its present target control policy τ (which ultimately is intended to be optimal). Control policy is also referred to as a behavior control policy.

Q learning is one example of an off-policy method. In this method, the agent learns a value estimation function Q that maps state-action pairs onto expected discounted returns. The target policy is a “greedy” control policy with regard to Q. When the agent is in a state [symbol] , it selects an action A according to behavior control policy b. After the agent has observed (for example, ascertained from sensor data) reward R obtained for such and state S′ reached by same, it updates its Q function as follows:

Q(S,A)=Q(S,A)+α[R+γmax,Q(S′,α)−Q(S,A)],

where α, 0<α≤1 is the step-size parameter that weighs new experiences against old estimations. When according to the behavior policy all state-action combinations are explored to a limit of infinity, the target control policy converges toward the optimal control policy.

One disadvantage of the Q learning is that the Q value is always updated for only one state-action pair. If a high reward is obtained at a point in time, this may possibly take many iterations (i.e., in particular many updates of the Q estimation function according to the above formula) until a corresponding update of the Q estimation function becomes noticeable in the initial state. To avoid this, according to various specific embodiments, updates are delayed until a high reward is observed, and the Q function updates are then applied in the reverse order of the observed rewards in order to efficiently backpropagate high estimations (i.e., high values of the Q estimation function for certain states) for the initial states.

Answer set programming is an approach for declarative problem solving with roots in knowledge representation, nonmonotonic inference, logic programming, and deductive databases. An answer set programming solver uses concepts of satisfiability (SAT) solvers and satisfiability modular theory (SMT) solvers, but implements nonmonotonic semantics that allow conclusions to be revoked in light of new information. According to various specific embodiments, for implementing a planning component, properties of problem solving (for example, actions and states thus reached) are initially modeled, using the input language of an answer set programming solver. An answer set programming solver is then used to compute the answer sets of the model, which in turn correspond to the solutions of the original problem. The performance of answer set programming is based on the expressive but simple modeling language on the one hand and powerful answer set programming solvers on the other hand.

Answer set programming is essentially a propositional formalism, and for most answer set programming solvers, variables in the input language are replaced by constant symbols in a preprocessing step referred to as “grounding.” In addition to variables, features of the input languages of the customary answer set programming solvers are integrity limitations, standard negation for expressing the absence of information, selection rules, and disjunction for expressing nondeterminism, aggregation, arithmetic, interpretable and noninterpretable function symbols, weak conditions, and optimization instructions.

An answer set programming program is a set of rules, a rule having the form

p, . . . , q :— r, . . . , s, not t, . . . , not u

All atoms preceding implication symbol :— are the head of a rule, and all atoms following symbol :— are the body.

The intuitive meaning of this rule is that when all atoms r, . . . , s may be derived and there is no evidence of any of atoms t, . . . , u, then at least one of p, . . . , q must be true. An interpretation is a set of atoms. An interpretation is an answer set of a program when it satisfies a certain fixed point condition which guarantees that all rules of the program are satisfied in a minimal and consistent manner. A program may include no answer set, one answer set, or more than one answer set.

A rule with an empty body is referred to as a fact. With facts, the implication symbol is normally omitted. Facts are used to express knowledge that is unconditionally true. A rule with an empty head is a condition:

:— r, . . . , s, not t, . . . , not u

A condition expresses that its body cannot be satisfied by any answer set. Conditions are used to remove undesirable solution candidates.

The following rule is a selection rule:

{p, . . . , q}:— r, . . . , s, not t, . . . , not u

This rule expresses that when the main part of a rule is satisfied, a subset of p, . . . , q must also be true.

For the purpose of illustration, as an example it is assumed that a robot may push against a door at any arbitrary point in time. The result of pushing against the door is that it is open in the next time increment. An example of an appropriate program is

{push(T)}:— time increment(T), closed(T).
open(T+1) :— time increment(T), push(T).
closed(T+1) :— time increment(T), closed(T), not open(T+1).
open(T+1) :— time increment(T), open(T), not closed(T+1).

The first rule expresses the selection of either pushing against the door if it is closed, or doing nothing. The second rule expresses the effects of pushing the door, namely, that it is subsequently open. The last two rules are boundary axioms that express that the status of the door remains unchanged if there is no evidence to the contrary.

As an example scenario, it is considered that there is a single time increment and an initially closed door, i.e.,

time increment(1).
closed(1).

The answer sets of the program are

{time increment(1) closed(1) push(1) open(2)}
and
{time increment(1) closed(1) closed(2)}

Each of these answer sets corresponds to a possible world in which the agent either pushes against the door or does nothing.

Dynamics function p: [symbol] × [symbol] × [symbol] × [symbol] [symbol] [0,1] is typically not completely known in a control scenario. However, knowledge about the control scenario is often present which may be utilized. According to various specific embodiments, this prior knowledge is represented as an answer set programming program, as the result of which a planning component is implemented.

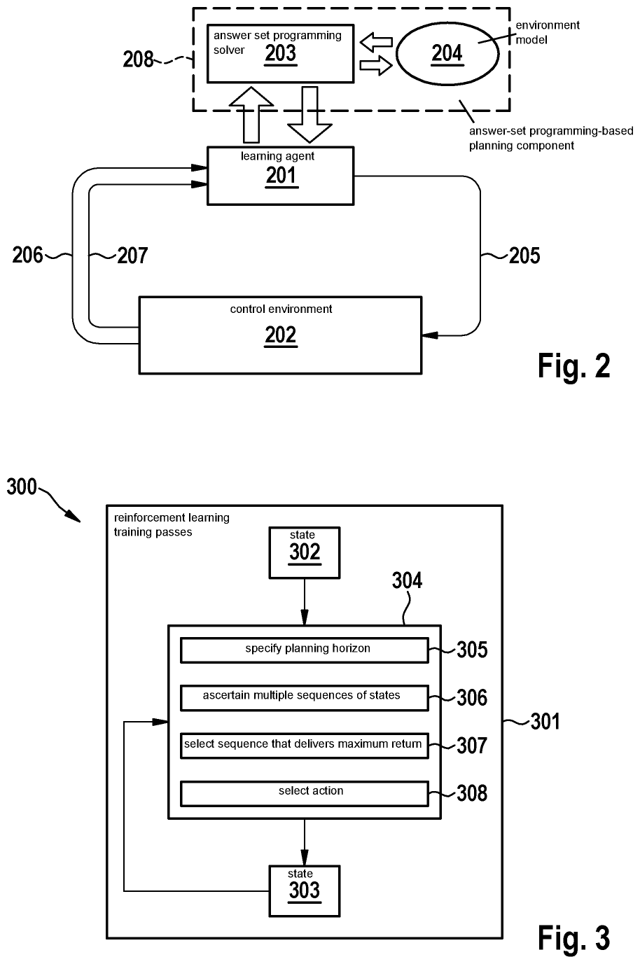

FIG. 2 illustrates an interaction between a learning agent 201 and control environment 202, the agent using an answer set programming-based planning component 208 including an answer set programming solver 203 and an environment model 204 for selecting actions.

Environment model 204 is an answer set programming program P that models the environment (with which the agent interacts). The environment model models in particular into which states the agent comes when carrying out certain actions. A parameter h indicates the planning horizon, i.e., the maximum number of actions. For a given state [symbol] , the answer sets of program P (where [symbol] is a fact) correspond to the trajectories of the agent according to model 204, starting from [symbol] with a maximum of h actions and the associated rewards. According to one specific embodiment, an optimization criterion for maximizing the return is indicated, and answer set programming solver 203 outputs only the answer set or answer sets that satisfies or satisfy this optimization criterion, for example the trajectory with the highest return within the planning horizon.

Whereas the MDP contains probability distributions, model 204 models rewards and state transitions deterministically (but optimistically) or nondeterministically. Rewards are modeled in answer set programming, using positive or negative integers.

The result of the computation of the answer set programming solver is referred to as ASP[P, h, S], and model P with the planning horizon set to h, together with the representation of state [symbol] , as input, are referred to as facts.

According to one specific embodiment, no discount is taken into account, since the finite planning horizon ensures that the return cannot go to infinity. However, it should be noted that the discount may still be used when the performance of the agent is evaluated.

One example of an environment model 204 that is consistent with the above example, in which a robot may open a door, is indicated below.

time increment(1 . . . h).
{push(T)}:— time increment(T), closed(T).
open(T+1) :— time increment(T), push(T).
closed(T+1) :— time increment(T), closed(T), not open(T+1).
open(T+1) :— time increment(T), open(T), not closed(T+1).
reward(T,−1) :— push (T−1).
reward(T,10) :— open(T).
#maximize {R,T: reward(T,R)}.

The first line defines the planning horizon, where h is a constant that is, for example, set by the agent prior to starting answer set programming solver 203. The reward is modeled in the last three lines: each pushing action is penalized by a negative reward of −1. However, the agent obtains a reward of 10 in each state in which the door is open. It is intuitively clear that the agent pushes the door open as soon as possible in order to maximize the return.

Upon retrieval of the answer set programming solver together with model P, time horizon 3, and an [symbol] in which the door is closed, i.e., S={closed(1)}, the answer set programming solver delivers an answer set ASP[P, 3, S] equal to

{time increment(1) time increment(2) time increment(3) closed(1) open(2) open(3) open(4) push (1) reward(2,−1) reward(2,10) reward(3,10) reward(4,10)}.

This corresponds to a trajectory in which in the first state the agent pushes against the door and subsequently carries out no further action.

The behavior control policy of agent 201 is now as follows, for example. It is assumed that the agent observes state [symbol] (i.e., observes that it is in state [symbol] ). If the agent observes state [symbol] for the first time (during learning), it computes set ASP[P, h, S] with the aid of the answer set programming solver, and the agent selects the first action (i.e., the action with time increment 1) from set ASP[P, h, S] as the action for state [symbol] . If the agent has already visited state [symbol] once or the answer set programming solver outputs no action in set [symbol] (S) of the available actions for state [symbol] , the agent selects a random action from [symbol] (S) having probability ε, and follows its target control policy π (as it is trained for the present training level) having probability 1−ε. Planning horizon h and the rate of random exploration ε are parameters of the learning in addition to model P, answer set programming solver 203 used, and answer set programming solver parameters such as computation time limitations.

If agent 201 carries out an action in 205, it obtains a reward 206 from environment 202 and observes successor state 207 that is reached. Beginning from an initial state, the agent repeats this loop until the particular RL training pass (rollout) is ended, for example because an end state has been reached or because the maximum number of actions has been reached. The RL training typically contains a plurality of such passes until a convergence criterion is reached (for example, when the change in the Q estimation is below a threshold value function for a certain number of updates).

According to the above strategy, long sequences of similar answer set programming solver retrievals typically result at the start of the learning process. If the agent observes a sequence of unknown states

S₀S₁S₂ . . .

it carries out the following sequence of answer set programming solver retrievals via:

$$A S P [ P , h , {S}_{0} ]$$

$$A S P [ P , h , {S}_{1} ]$$

$$A S P [ P , h , {S}_{2} ]$$

$$⋮$$

This means that problems that are closely related to one another are solved in succession by answer set programming solver 203. To reduce the computing time, according to one specific embodiment multi-shot solving is therefore used, which some answer set programming solvers support, in order to maintain the answer set programming solver state while the answer set programming solver operates with a changing program. The above sequence of answer set programming solver retrievals may be regarded as an incremental planning problem with a sliding planning horizon, the beginning of the trajectory being fixed:

$$A S P [ P , h , {S}_{0} ]$$

$$A S P [ P , h + 1 , {S}_{0} ⋃ {S}_{1} ]$$

$$A S P [ P , h + 2 , {S}_{0} ⋃ {S}_{1} ⋃ {S}_{2} ]$$

$$⋮$$

Instead of using individual answer set programming solver retrievals, agent 201 may reach this sequence of computations via incremental updates, starting from the first answer set programming solver retrieval. The computing time resulting from planning component 208 may be reduced in this way.

In summary, according to various specific embodiments a method is provided as illustrated in FIG. 3.

FIG. 3 shows a flowchart 300 that illustrates a method for training a control strategy with the aid of reinforcement learning.

Multiple reinforcement learning training passes 301 are carried out, an action that is to be carried out being selected in each reinforcement learning training pass 301 for each state 302, 303 of a sequence of states of an agent, beginning with an initial state 302 of control pass, in 304.

For at least some of states 302, 303, the particular action is selected by:

Specifying a planning horizon, which predefines a number of states, in 305.

Ascertaining multiple sequences of states, reachable from the particular state, using the predefined number of states, by applying an answer set programming solver to an answer set programming program which models the relationship between actions and the successor states that are reached by the actions, in 306.

Selecting from the ascertained sequences the sequence among the ascertained sequences that delivers the maximum return, the return that is delivered by an ascertained sequence being the sum of the rewards that are obtained upon reaching the states of the sequence, in 307.

Selecting an action as the action for particular state 302, 303 via which the first state of the selected sequence may be reached, starting from particular state 302, 303, in 308.

A control strategy corresponds, for example, to what is referred to as a “control policy” in the above examples.

According to various specific embodiments, in other words a specific behavior control policy is established which provides for the use of an answer set programming solver when a decision is to be made about an action to be carried out. This approach may be used together with any off-policy method to enable the agent to utilize prior knowledge, while maintaining the robustness of the (original) off-policy method. Various exemplary embodiments merely require that states may be represented as relationships between objects, so that the states may be used as input for a planning component, and that a declarative model of the environment, specified in advance, is specified in an input language of the answer set programming solver used.

A concept underlying various exemplary embodiments may be considered to be that a behavior control policy is defined that enables an agent to find high rewards in environments in which rewards are rare. According to various exemplary embodiments, the control policy is a mixture of random exploration, exploitation of things that have already been learned, and planning using a (high-level, for example) model of the environment.

The learned control strategy is, for example, a control strategy for a robotic device. A “robotic device” may be understood to mean any physical system (including a mechanical part whose movement is controlled), such as a computer-controlled machine, a vehicle, a household appliance, a power tool, a production machine, a personal assistant, or an access control system.

Various specific embodiments may receive and use sensor signals from various sensors such as video sensors, radar sensors, LIDAR sensors, ultrasonic sensors, motion sensors, acoustic sensors, thermal imaging sensors, etc., in order to obtain, for example, sensor data concerning system states (robot and object or objects) as well as control scenarios. The sensor data may be processed. This may involve classifying the sensor data or carrying out a semantic segmentation of the sensor data, for example to recognize the presence of objects (in the environment in which the sensor data were obtained). Exemplary embodiments may be used to train a machine learning system and autonomously control a robot in order to implement various manipulation tasks under various scenarios. In particular, exemplary embodiments for controlling and supervising the performance of manipulation tasks may be applied in assembly lines, for example. They may be integrated, seamlessly, for example, into a traditional GUI for a control process.

The method is computer-implemented according to one specific embodiment.

Although the present invention has been illustrated and described primarily with respect to certain specific embodiments, it should be understood by those familiar with the technical field that numerous modifications with regard to design and details thereof may be made without departing from the nature and scope of the present invention.

1-9. (canceled)

10. A method for training a control strategy using reinforcement learning, comprising the following steps:
carrying out multiple reinforcement learning training passes, in each reinforcement learning training pass, a respective action that is to be carried out being selected for each state of a sequence of states of an agent, beginning with an initial state of a control pass, and, for at least some of the states, the respective action being selected by specifying a planning horizon that predefines a number of states;
ascertaining multiple sequences of states, reachable from a particular state, using the predefined number of states, by applying an answer set programming solver to an answer set programming program which models a relationship between actions and successor states that are reached by the actions;
selecting from the ascertained sequences, that sequence among the ascertained sequences that delivers a maximum return, a return that is delivered by each ascertained sequence being a sum of rewards that are obtained upon reaching states of the sequence; and
selecting an action as the respective action for the particular state via which a first state of the selected sequence may be reached, starting from the particular state.

11. The method as recited in claim 10, wherein for each state that is reached in a reinforcement learning training pass, a check is made as to whether the state was reached for the first time in the multiple reinforcement learning training passes, and the respective action is ascertained by ascertaining the multiple sequences, selecting the sequence among the ascertained sequences that delivers the maximum return, and selecting the respective action via which the first state of the selected sequence, starting from the state, may be reached, when the state was reached for the first time in the multiple reinforcement learning training passes.

12. The method as recited in claim 11, wherein for each state that has already been reached in the multiple reinforcement learning training passes, the respective action is selected according to a previously trained control strategy, or randomly.

13. The method as recited in claim 10, wherein for each state of at least some of the states the respective action is selected by:
specifying a first planning horizon that predefines a first number of states;
ascertaining multiple sequences of states that are reachable from the state, using the first number of states, by applying an answer set programming solver to an answer set programming program which models the relationship between actions and successor states that are reached by the actions; and
when, for ascertaining the respective action for the particular state, a predefined available computation budget is depleted, selecting from the ascertained sequences, using the first number of states of the sequence, the sequence among the ascertained sequences that delivers the maximum return, and selecting an action as the respective action for the particular state via which the first state of the selected sequence may be reached, starting from the particular state; and
when, for ascertaining the respective action for the particular state, the predefined available computation budget is not yet depleted, specifying a second planning horizon that predefines a second number of states, the second number of states being greater than the first number of states, ascertaining multiple sequences of states that are reachable from the respective state, using the second number of states, by applying the answer set programming solver to the answer set programming program which models the relationship between actions and the successor states that are reached by the actions, selecting from the ascertained sequences, using the second number of states, that sequence among the ascertained sequences that delivers the maximum return, and selecting an action as the respective action for the particular state via which the first state of the selected sequence, starting from the particular state, may be reached.

14. The method as recited in claim 11, wherein the answer set programming solver assists with multi-shot solving, and the multiple sequences for successive states in each reinforcement learning training pass are ascertained by multi-shot solving using the answer set programming solver.

15. The method as recited in claim 11, further comprising:
controlling a robotic device based on the trained control strategy.

16. A control device configured to train a control strategy using reinforcement learning, the control device configured to:
carry out multiple reinforcement learning training passes, in each reinforcement learning training pass, a respective action that is to be carried out being selected for each state of a sequence of states of an agent, beginning with an initial state of a control pass, and, for at least some of the states, the respective action being selected by specifying a planning horizon that predefines a number of states;
ascertain multiple sequences of states, reachable from a particular state, using the predefined number of states, by applying an answer set programming solver to an answer set programming program which models a relationship between actions and successor states that are reached by the actions;
select from the ascertained sequences, that sequence among the ascertained sequences that delivers a maximum return, a return that is delivered by each ascertained sequence being a sum of rewards that are obtained upon reaching states of the sequence; and
select an action as the respective action for the particular state via which a first state of the selected sequence may be reached, starting from the particular state.

17. A non-transitory computer-readable memory medium on is stored a computer program including program instructions for training a control strategy using reinforcement learning, the computer program, when executed by one or more processors, causing the one or more processors to perform the following steps:
carrying out multiple reinforcement learning training passes, in each reinforcement learning training pass, a respective action that is to be carried out being selected for each state of a sequence of states of an agent, beginning with an initial state of a control pass, and, for at least some of the states, the respective action being selected by specifying a planning horizon that predefines a number of states;
ascertaining multiple sequences of states, reachable from a particular state, using the predefined number of states, by applying an answer set programming solver to an answer set programming program which models a relationship between actions and successor states that are reached by the actions;
selecting from the ascertained sequences, that sequence among the ascertained sequences that delivers a maximum return, a return that is delivered by each ascertained sequence being a sum of rewards that are obtained upon reaching states of the sequence; and
selecting an action as the respective action for the particular state via which a first state of the selected sequence may be reached, starting from the particular state.
